(19) United States
(12) Patent Application Publication
(10) Pub. No.: US 2020/0103966 A1
(43) Pub. Date: Apr. 2, 2020

(54) HAPTIC ACTUATOR HAVING A BLADDER AND ONE OR MORE CONSTRAINING STRUCTURES

(71) Applicant: IMMERSION CORPORATION, San Jose, CA (US)

(72) Inventors: Vahid KHOSHKAVA, Montreal (CA); Mansoor ALGHOONEH, Montreal (CA); Simon FOREST, Montreal (CA)

(21) Appl. No.: 16/145,959

(22) Filed: Sep. 28, 2018

(51) Int. Cl. G06F 3/01; A63F 13/24

(52) U.S. Cl. CPC G06F 3/014; A63F 13/285; A63F 13/24

(57) ABSTRACT

A haptic actuator comprising an elongate bladder, a pressure control component, and a constraining structure. The elongate bladder is stretchable along a length dimension thereof. The pressure control component is configured to increase pressure of a fluid in the bladder, which causes a first surface portion of the elongate bladder to stretch along the length dimension thereof. The constraining structure is attached to a second and opposite surface portion of the elongate bladder and is less stretchable than the elongate bladder so as to constrain the second surface portion of the elongate bladder from stretching along the length dimension thereof. When the pressure control component is activated to increase the pressure of the fluid, the constraining structure permits the first surface portion to stretch along the length dimension by a greater amount relative to the second surface portion, which causes the elongate bladder to bend.

### FIELD OF THE INVENTION

The present invention is directed to a haptic actuator configured to generate a bending deformation and having a bladder and one or more constraining structures, and has application in gaming, consumer electronics, automotive, entertainment, and other industries.

### BACKGROUND

Haptics provide a tactile and force feedback technology that takes advantage of a user's sense of touch by applying haptic effects, such as forces, vibrations, and other motions to a user. Devices such as mobile devices, tablet computers, and handheld game controllers can be configured to generate haptic effects. Haptic effects can be generated with haptic actuators, such as an eccentric rotating mass (ERM) actuator or a linear resonant actuator (LRA). The haptic effects may include a kinesthetic haptic effect and a vibrotactile haptic effect.

### SUMMARY

One aspect of the embodiments herein relates to a haptic actuator for generating bending deformation. The haptic actuator comprises an elongate bladder, a pressure control component, and a constraining structure. The elongate bladder comprises a layer of elastic material formed to enclose a fluid, wherein the elongate bladder is stretchable along at least a length dimension thereof. The pressure control component is configured, when activated, to cause an increase in pressure of the fluid enclosed by the elongate bladder, wherein the increase in the pressure of the fluid causes at least a first surface portion of the elongate bladder to stretch along the length dimension thereof. The constraining structure is flexible and is attached to a second surface portion of the elongate bladder, wherein the first surface portion and the second surface portion are diametrically opposed to each other, wherein the constraining structure is less stretchable than the elongate bladder so as to constrain the second surface portion of the elongate bladder from stretching along the length dimension thereof. When the pressure control component is activated to increase the pressure of the fluid, the constraining structure permits the first surface portion of the elongate bladder to stretch along the length dimension by a greater amount relative to the second surface portion, and wherein the greater amount of stretching on the first surface portion of the elongate bladder relative to the second surface portion thereof is configured to bend the elongate bladder.

### BRIEF DESCRIPTION OF THE DRAWINGS

The foregoing and other features, objects and advantages of the invention will be apparent from the following detailed description of embodiments hereof as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 depicts a block diagram of a haptic actuator comprising a bladder and a constraining structure, according to an embodiment hereof.

FIGS. 2A and 2B depict haptic actuators having a bladder and first and second constraining structures, according to embodiments hereof.

FIGS. 3A-3G depict a haptic actuator generating a bending deformation, according to an embodiment hereof.

FIG. 4A depicts a haptic-enabled device incorporating a haptic actuator that has a bladder and one or more constraining structures, according to an embodiment hereof.

FIG. 4B depicts a haptic-enabled glove incorporating a haptic actuator that has a bladder and one or more constraining structures, according to an embodiment hereof.

FIGS. 5A and 5B depict a haptic actuator having a bladder, a constraining structure, and a shape memory alloy (SMA) coil, according to an embodiment hereof.

FIGS. 6A-6C depict a haptic actuator having a bladder, a constraining structure, and an electroactive polymer (EAP) component, according to an embodiment hereof.

FIGS. 7A-7C depict a haptic actuator having a bladder, a constraining structure, and an electroactive polymer (EAP) component, according to an embodiment hereof.

FIGS. 8A-8C depict a haptic actuator having a bladder made of EAP material, according to an embodiment hereof.

FIGS. 9A and 9B depict a haptic actuator having a bladder that encloses a fluid having a hydrogel, according to an embodiment hereof.

FIGS. 10A and 10B depict a haptic actuator that comprises a bladder made from a shape memory polymer (SMP) material and comprises a SMA coil, according to an embodiment hereof.

FIG. 11 depicts a haptic actuator having a bladder, constraining structure, and a pneumatic pump or hydraulic pump, according to an embodiment hereof.

FIG. 12 depicts a haptic actuator having a layer of EAP material attached to a bladder, according to an embodiment hereof.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

One aspect of the embodiments described herein relates to a haptic actuator that comprises a bladder and is configured to convert stretching of the bladder into a bending deformation or other form of deformation, which may be used to generate a kinesthetic haptic effect. The bladder and the other components of the haptic actuator may be lightweight, but may still be able to generate a large amount of force and/or large amount of displacement. In some cases, the bladder of the haptic actuator may hold fluid and may be stretched as pressure of the fluid increases. The haptic actuator may include one or more constraining structures to constrain the stretching of the bladder. For instance, one constraining structure (e.g., a coil, also referred to as a spiral winding or helical winding, having multiple turns) may force the bladder to stretch along only a length dimension thereof, while another constraining structure (e.g., an inextensible sheet) may force one surface portion of the bladder (e.g., a bottom portion) to not stretch at all, or to stretch by a lesser amount than another surface portion (e.g., a top portion) of the bladder. The influence of the one or more constraining structures may convert the stretching of the bladder into a force that bends the bladder toward, e.g., the surface portion experiencing less stretching.

In an embodiment, the haptic actuator may be part of a haptic-enabled user interface device, such as a handheld game controller, a wearable device (e.g., a glove such as an exoglove), or any other user interface device. For instance, the haptic-enabled user interface device may be a gaming glove used to receive user input, such as user input for a virtual reality (VR) or augmented reality (AR) application, or user input for controlling another device. For the gaming glove, the bladder of the haptic actuator may in an embodiment have an elongated shape that is oriented along a finger sheath of the gaming glove. When the haptic actuator is generated, it may be configured to generate a kinesthetic haptic effect in the form of a bending force applied to the finger sheath, which may translate into a bending force on a finger of a user wearing the gaming glove.

In an embodiment, the bladder of the haptic actuator may be stretched by increasing a pressure of a fluid (also referred to as fluid pressure) within the bladder. For instance, the bladder may have a membrane made of an elastic material with a low Young's modulus, which in some embodiments is more particularly an elastomeric material. The elastic material of the bladder may enclose a space filled with a fluid (e.g, a saline solution), and the fluid may exert an outward pressure on the elastic material. In an embodiment, the haptic actuator may include a pressure control component that is configured to actively control (e.g., increase or decrease) the fluid pressure exerted by the fluid on the membrane of the bladder. Because the pressure control component is configured, when activated, to actively increase or actively decrease the pressure exerted by the fluid, it may also be referred to as an active pressure control component.

In some embodiments, the pressure control component may be a compressing apparatus configured to squeeze or otherwise compress the bladder along one of its dimensions, such as a radial dimension, in order to decrease a size of the bladder along that dimension, and/or to decrease a volume of the space within the bladder. Because the volume of the space is decreased, the pressure of the fluid within the space increases. The increase in fluid pressure may be used to generate the stretching of the bladder along another dimension, and to generate the bending deformation of the haptic actuator. In an embodiment, the pressure control component may rely on the use of a smart material component, such as a shape memory alloy (SMA) component, an electroactive polymer (EAP) component, and/or a shape memory polymer (SMP) component to actively squeeze or otherwise compress the bladder and the fluid within the bladder. In an embodiment, the pressure control component may perform its function without the use of a pneumatic pump or hydraulic pump, which may be omitted from the haptic actuator. In an embodiment, a pneumatic pump or hydraulic pump may be combined with the smart material component discussed above, or may replace the smart material component.

In an embodiment, a pressure control component may rely on expansion of a hydrogel in order to increase fluid pressure and stretch the bladder. For instance, the pressure control component may include a hydrogel stimulation apparatus that is configured to apply a thermal stimulus, electrical stimulus, light stimulus, or some other stimulus that will trigger an expansion of the hydrogel. Such features of this embodiment may also replace or be combined with the use of a pneumatic or hydraulic pump.

As discussed above, the haptic actuator may include a constraining structure that causes uneven stretching between two surface portions of the bladder, wherein one of the surface portions is directly attached to the constraining structure, and the other surface portion may be an opposite surface portion that is not directly attached to the constraining structure. In some cases, the two surface portions may be diametrically opposed to each other. For instance, one of the surface portions may be on a first side of the space enclosed by the bladder, while the other surface portion may be on a second and opposite side of the space. In other words, the two surface portions may in some cases be opposite portions of a lateral surface of the bladder. In an embodiment, the constraining structure may be an elongate structure, such as an elongate sheet or an elongate tube, that runs along a length dimension or other dimension of the bladder. In such an embodiment, the bladder may be referred to as an elongate bladder. The constraining structure may be flexible so that it is able to bend but may be less stretchable (also referred to as being less extensible) along a length dimension of the bladder (or, more generally, along a first dimension of the bladder) relative to the ability of the elastic material of the bladder to strength along the length dimension thereof (or, more generally, along the first dimension of the bladder). For instance, the constraining structure may have a Young's modulus along one dimension that is considerably higher than the Young's modulus of the bladder along the same dimension. In an embodiment, a constraining structure may be bonded to a first surface portion of the bladder, such as a bottom surface portion. As discussed above, the haptic actuator may also include another constraining structure that prevents or otherwise constrains the bladder from expanding in a dimension perpendicular to the length dimension. The former constraining structure may be referred to as a first constraining structure, and the latter constraining structure may be referred to as a second constraining structure. As a result of the influence from the second constraining structure, any expansion of the bladder may be forced to occur along the length dimension.

In an embodiment, the second constraining structure may be formed from a fiber that is helically wound around the bladder or wound around the bladder in some other manner. When the fiber is wound around the bladder, it may be referred to as a coil, also referred to as a helical winding, which may reinforce a membrane of the bladder against outward expansion along any dimension perpendicular to the length dimension. Thus, embodiments of such a haptic actuator described herein may be referred to as a fiber-reinforced actuator. In an embodiment, the coil may be substantially as long as the bladder. In other words, a size of the coil along a length dimension thereof (i.e., a length dimension of the coil) may be substantially the same as a size of the bladder along a length dimension thereof (i.e., a length dimension of the bladder). In an embodiment, the coil may further have a radial dimension that is perpendicular to the length dimension.

In an embodiment, when there is an increase in fluid pressure within the bladder, the second constraining structure may channel the increased pressure into expansion of the bladder along its length dimension, rather than along its radial dimension. Because the first constraining structure is attached to, e.g., the bottom surface portion of the bladder, it may constrain the ability of the bottom surface portion of the bladder to expand along the length dimension of the bladder. Because the first constraining structure is not attached to, e.g., the top surface portion of the bladder, the ability of the top surface portion of the bladder (or of any other surface portion not directly attached to the bladder) to expand along the length dimension may be unaffected or much less affected by the first constraining structure. As a result, the bottom surface portion of the bladder may experience no expansion or only a small amount of expansion along the length dimension relative to the amount of expansion experienced by the top surface portion of the bladder. This uneven amount of expansion along the length dimension between the top surface portion and the bottom surface portion of the bladder may generate a force that bends the bladder toward the bottom surface portion thereof.

In an embodiment, as stated above, a pressure control component of the haptic actuator may include a SMA component that is able to shrink in size, and to compress the bladder as a result of shrinking in size. For instance, the SMA component may include a SMA fiber (also referred to as a SMA filament) that is wound around the bladder. In such an instance, the SMA fiber may be referred to as a SMA coil. In an embodiment, the SMA coil may also function as the second constraining structure as described above.

In an embodiment, the SMA component may be a SMA material, such as a nickel titanium alloy, that underwent a thermomechanical treatment to train the SMA material to revert or otherwise change to a particular shape (which may be referred to as a trained shape) when the SMA component is activated by a thermal stimulus other stimulus. In other words, the SMA component may be characterized as exhibiting a shape memory effect or as having been imparted with a shape memory (also referred to as a mechanical memory). In an embodiment, the SMA component may exhibit a two-way shape memory effect in which the SMA component was trained via the thermomechanical treatment to revert to or otherwise change to a first shape when the SMA component is in a martensite phase (which may also be referred to as a low-temperature phase), and to revert to or otherwise change to a second shape when the SMA component is in an austenite phase, which may also be referred to as a high-temperature phase. When the SMA component is a SMA coil, the first shape and/or the second shape may be that of a coil (also referred to as a helical winding). However, the second shape may be smaller than the first shape. More particularly, the first shape may be a first coil having a radius, while the second shape may be a second coil having a second radius, wherein the second radius is smaller than the first radius. In this situation, when the SMA coil changes from the first shape to the second shape as part of a phase transition, it effectively shrinks in radius. Thus, the shape change causes the SMA coil to squeeze or otherwise compress the bladder, because the SMA coil is wrapped around the bladder. As a result of the compression, fluid pressure within the bladder may increase.

In an embodiment, as stated above, a pressure control component of the haptic actuator may rely on the use of an EAP component. In an embodiment, the EAP component may include a material (e.g., polyvinylidene fluoride (PVDF)) that is configured to expand in thickness when a voltage difference having a first polarity is applied to the material, and to contract in thickness when a voltage difference having an opposite polarity is applied to the material. The material may be bonded to at least one side of the bladder, and expansion of the material upon activation may cause it to press inward against the surface portion of the bladder to which the PVDF is attached. The pressing on the bladder may cause the bladder to decrease in size along a particular dimension, such as a radial dimension. As a result, a fluid in the bladder may increase in pressure and stretch the bladder along another dimension, such as its length dimension. In an embodiment, the EAP component may include a dielectric elastomer disposed between two electrodes. In another embodiment, the EAP component may directly bend in response to a voltage signal being applied to the PVDF or other material of the EAP component. The bending may occur, for instance, without relying on compressing a fluid in the bladder. Thus, such an embodiment may omit the presence of the fluid in the bladder.

In an embodiment, a bladder and an EAP component may be different components of the haptic actuator. In another embodiment, a bladder may be an EAP component. More specifically, the bladder itself may be made of an EAP material, such as a dielectric elastomer or terpolymer PVDF. For instance, an elastic material of an EAP material may be used for forming a membrane of the bladder. When a voltage difference having a first polarity is applied to the membrane, the membrane may expand in thickness. The expansion may be in at least an inward direction with respect to the bladder, which may reduce a volume enclosed by the membrane. As a result, fluid pressure within the bladder may increase. When a voltage difference having a second and opposite polarity is applied to the membrane, the membrane may contract in thickness. In another embodiment, an elastic material forming a membrane of the bladder may be made of a shape memory polymer (SMP). In some cases, the SMP membrane may be combined with the SMA coil described above. The SMP membrane may be used to bend the bladder, while the SMA coil in such an embodiment may be used to unbend (e.g., straighten) the bladder.

In an embodiment, as stated above, a pressure control component may rely on controlling a volume of a hydrogel. More specifically, this embodiment may involve a bladder being filled with a fluid that includes a hydrogel and may further include a hydrogel stimulation apparatus that is part of a pressure control component. The hydrogel stimulation apparatus may be configured to activate the hydrogel by applying a thermal stimulus (e.g., heat), a chemical stimulus (e.g., a change in pH or ion strength), a light stimulus (e.g., ultraviolet light or infrared light), magnetic stimulus, electrical stimulus, or some other stimulus. When activated, the hydrogel may expand in volume, which may cause the hydrogel to push against the membrane of the bladder and exert an increased amount of fluid pressure.

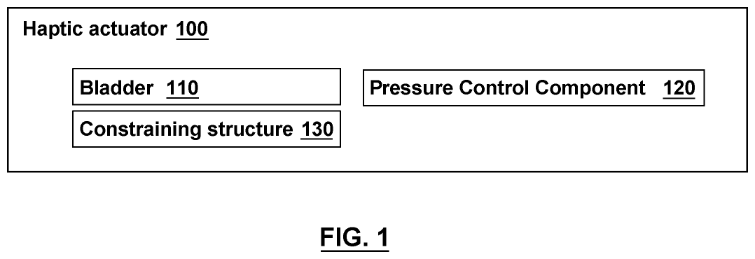

FIG. 1 depicts a block diagram of a haptic actuator 100 that is configured to generate a bending deformation or other type of deformation. The haptic actuator 100 includes a bladder 110, a constraining structure 130, and a pressure control component 120. In an embodiment, the haptic actuator 100 may be used to generate a kinesthetic haptic effect for a user interface device, such as a handheld game controller or a wearable device. In an embodiment, the bladder 110 may comprise a layer of elastic material that forms a membrane of the bladder 110. The membrane may be sealed or sealable, and may enclose a space for holding or containing a fluid, such as a liquid or a gas. In some cases, the haptic actuator 100 may be fabricated without filling the bladder 110 with fluid, and the fluid may later be filled into the bladder 110 by an end user.

In an embodiment, a bladder 110 may be an elongate bladder having an elongate structure, such as the structure of a tube, and may thus have a length dimension. The elastic material, such as rubber or another elastomeric material, may allow the membrane of the bladder to be stretchable along a first dimension, such as the length dimension, of the bladder 110. In an embodiment, fluid that is in the bladder 110 may be pressurized. For instance, the fluid in the bladder 110 may comprise pressurized air or a pressurized liquid having a baseline pressure of 101 kilo-Pascal (kPa), wherein the baseline pressure may be a pressure of the fluid within the bladder 110 when the bladder 110 is not being actively compressed, and/or the haptic actuator is not being used to generate a deformation.

In an embodiment, a constraining structure 130 may be directly or indirectly attached to the bladder 110 and may be configured to cause a respective amount of stretching on opposite surface portions of the bladder 110 (e.g., opposite sides of the bladder 110) to be uneven. As stated above, the constraining structure 130 may be flexible (e.g., bendable), but may resist being stretched along a particular dimension. That dimension may be, e.g., a length dimension or some other dimension of the constraining structure. In some instances, if the constraining structure is aligned with the bladder 110, such as after being attached to the bladder 110, the constraining structure may also be characterized as resisting being stretched along a dimension of the bladder 110. For instance, the constraining structure 130 may be characterized as being considerably less stretchable along a first dimension (e.g., a length dimension) of the bladder 110 relative to an ability of the elastic material of the bladder 110 to be stretched along the first dimension thereof. In this example, the constraining structure 130 may have a Young's modulus along the first dimension that is at least 10 times to 100 times greater than a Young's modulus of the bladder 110 along the first dimension. The constraining structure 130 may be bonded to one surface portion (e.g., one side) of the bladder 110, so as to constrain an ability of that surface portion of the bladder to stretch along the first dimension. This constraint may cause an opposite surface portion (e.g., an opposite side) of the bladder 110, which is not directly attached to a constraining structure, to stretch by a greater amount.

In some cases, the constraining structure may be an elongate sheet or an elongate tube. The elongate sheet may be able to conform to a contour of the bladder 110. For instance, if the bladder 110 has a concavo-convex cross-section, the elongate sheet may also have the same concavo-convex cross-section, in order to maximize contact area with the bladder 110. The elongate structure of the constraining structure 130 may allow it to be flexible (or, more specifically bendable), but the material of the constraining structure may make it difficult to stretch along the first dimension (e.g., length dimension). In some cases, when an increase in fluid pressure attempts to stretch a surface portion of the bladder 110 bonded to the constraining structure 130, the constraining structure 130 may still allow that surface portion of the bladder 110 to stretch by some amount along the first dimension. In another embodiment, the constraining structure 130 may be sufficiently stiff along the first dimension such that it substantially maintains its size along the first dimension, and substantially or completely prevents stretching of that surface portion of the bladder 110 along the first dimension, up to a defined maximum rated fluid pressure (e.g., air pressure) of 50 kPa relative to the baseline pressure. In such an embodiment, the constraining structure 130 may be referred to as being inextensible or stiff along the first dimension. In an embodiment, the constraining structure may be formed from a thermoplastic polymer, such as polypropylene or some other plastic. In an embodiment, the constraining structure may comprise a thin sheet formed from steel fibers, glass fibers, carbon fibers, or any combination thereof.

In an embodiment, a pressure control component 120 may be configured to actively control a pressure of a fluid (i.e., fluid pressure) within the bladder 110, or more specifically to increase the fluid pressure. In an embodiment, during operation of the haptic actuator 100, the pressure control component 120 may be configured, when activated, to increase the fluid pressure in the bladder 110 from a baseline value of, e.g., 101 kPa to an increased value of, e.g., 151 kPa. The pressure control component 120 may rely on, e.g., mechanical compression, to increase the fluid pressure in the bladder 110.

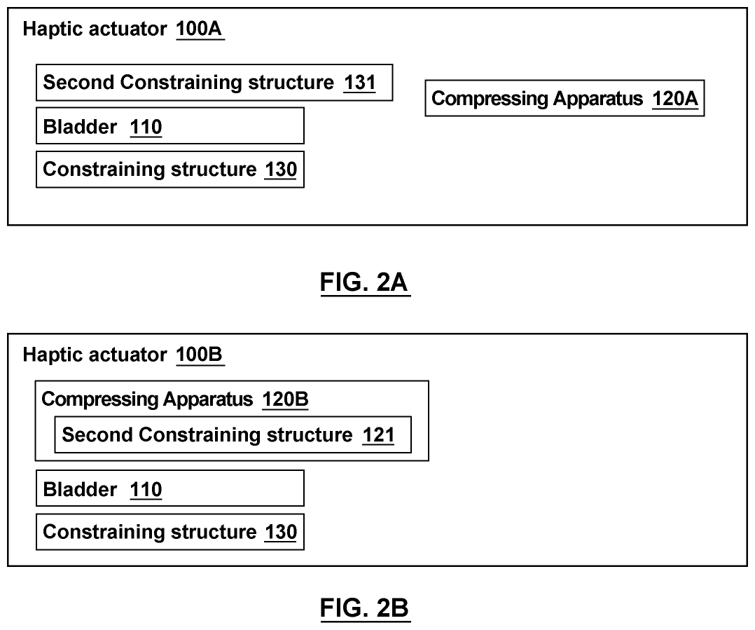

As stated above, the haptic actuator 100 may include a first constraining structure and a second constraining structure. FIG. 2A illustrates a haptic actuator 100A (which is an embodiment of the haptic actuator 100) having the constraining structure 130, which may be the first constraining structure, and a second constraining structure 131. While the first constraining structure 131 constrains an ability of the bladder 110 to stretch or otherwise expand along a first dimension thereof, the second constraining structure 131 may constrain an ability of the bladder 110 to stretch or otherwise expand along a second dimension thereof. In the embodiment of FIG. 2A, fluid pressure in the bladder 110 may be actively increased by the compressing apparatus 120A, which may be an embodiment of the pressure control component 120. While the compressing apparatus 120A may be an active component that actively compresses the bladder 110, the second constraining structure 131 may be a passive component that merely constrains the bladder 110, and is not used to actively compress the bladder 110. For instance, the compressing apparatus 120A may include an EAP component, and the second constraining structure 131 may include a steel coil that is not used to actively compress the bladder 110.

FIG. 2B illustrates a haptic actuator 100B (which is also an embodiment of the haptic actuator 100) in which the second constraining structure 121 is an active component that may be part of a compressing apparatus 120B. For instance, the second constraining structure 121 may include a SMA coil that both constrains the ability of the bladder 110 to expand outward and can be used to actively compress the bladder 110.

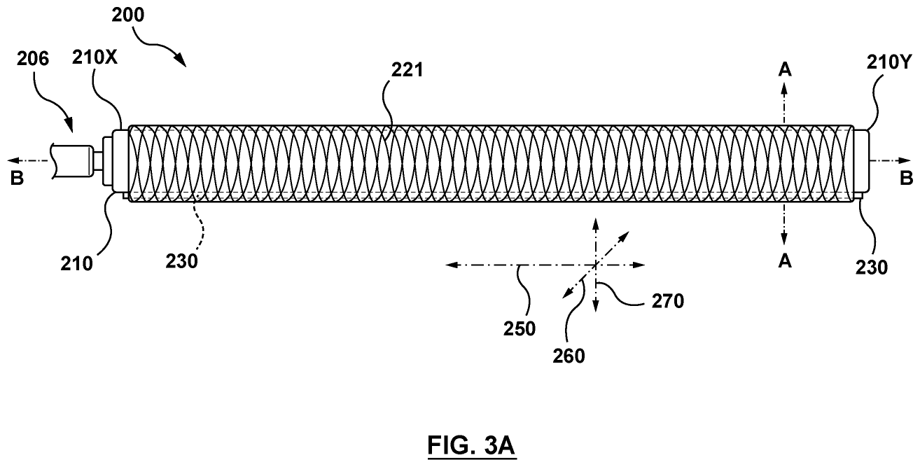

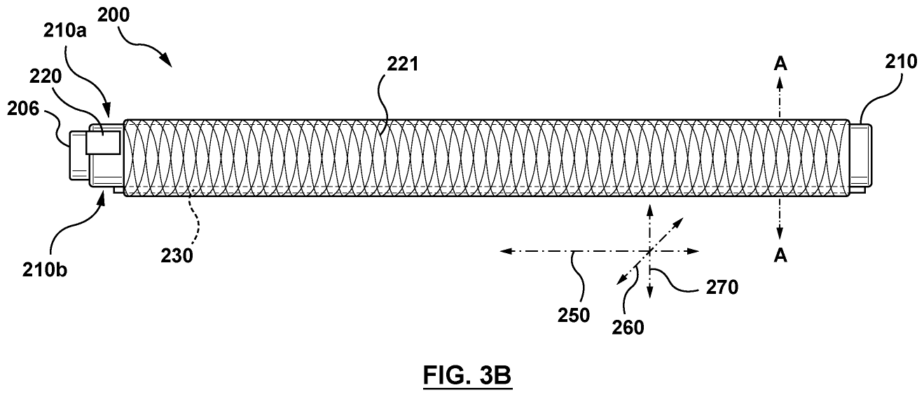

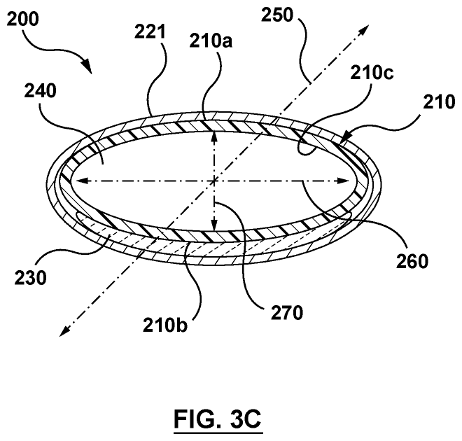

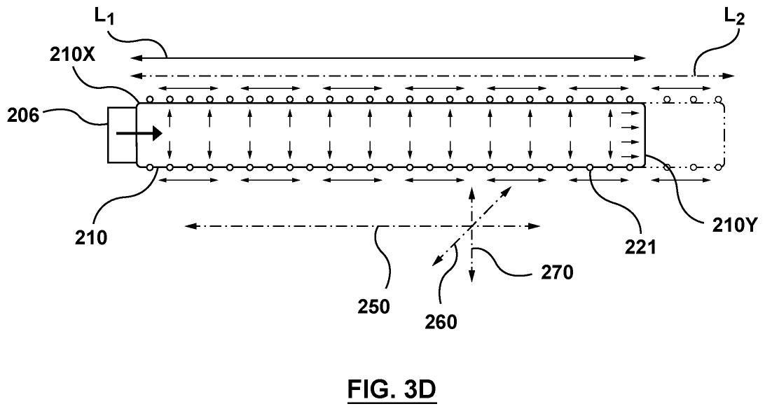

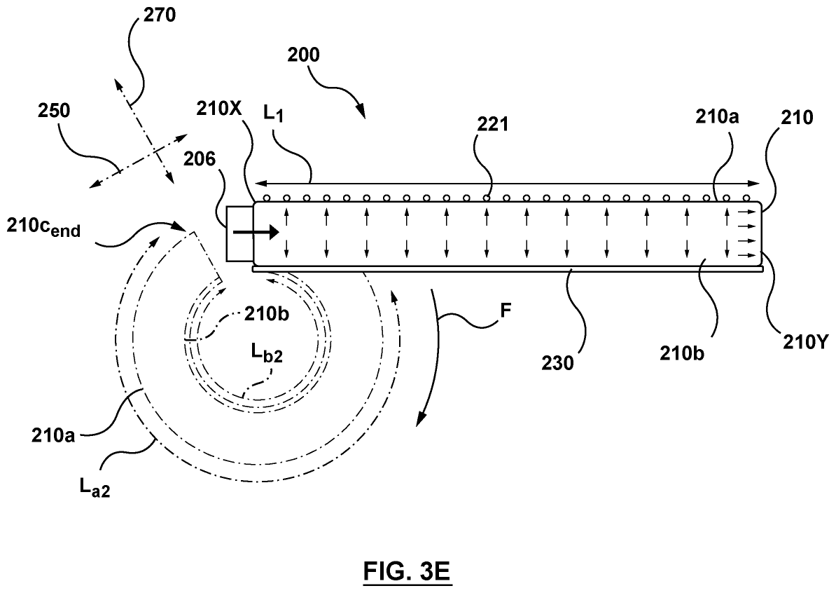

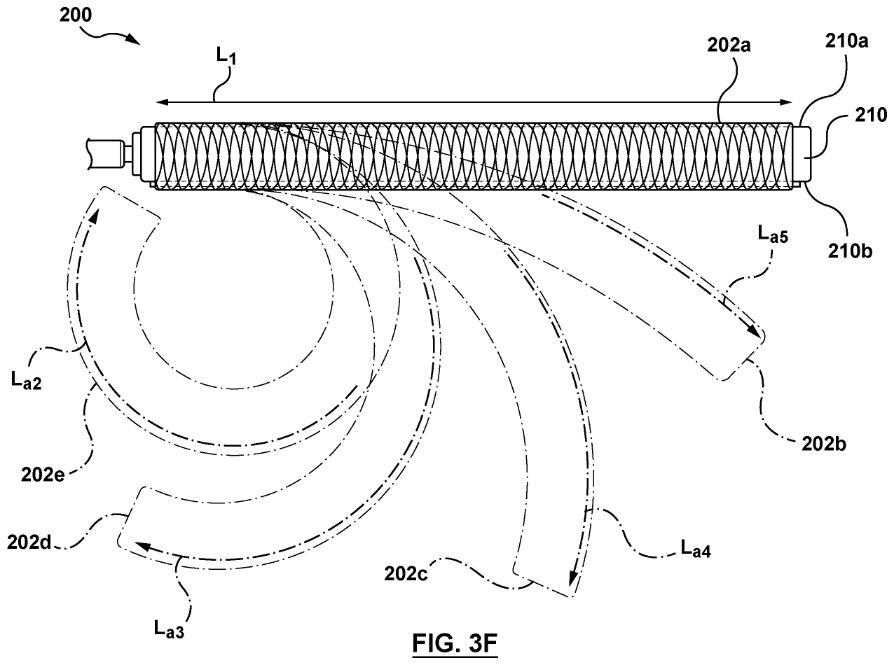

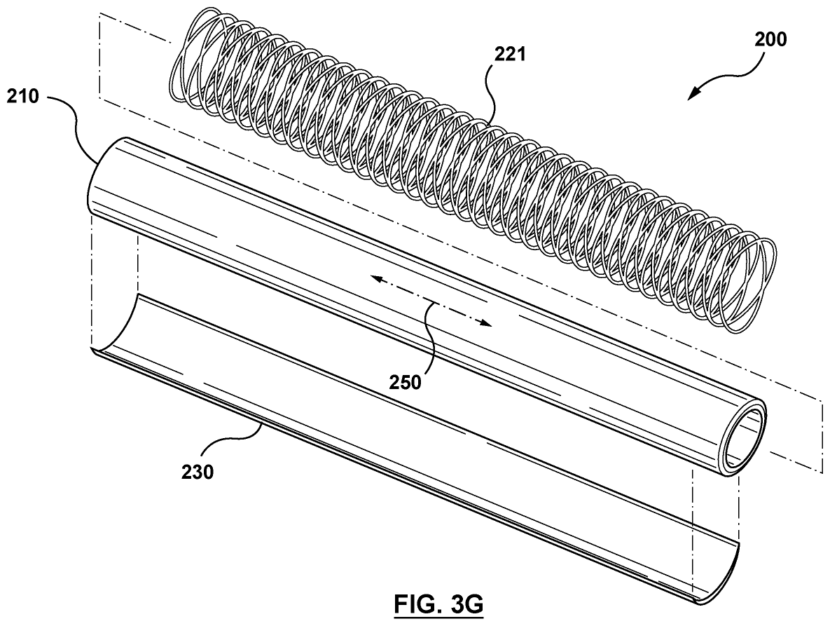

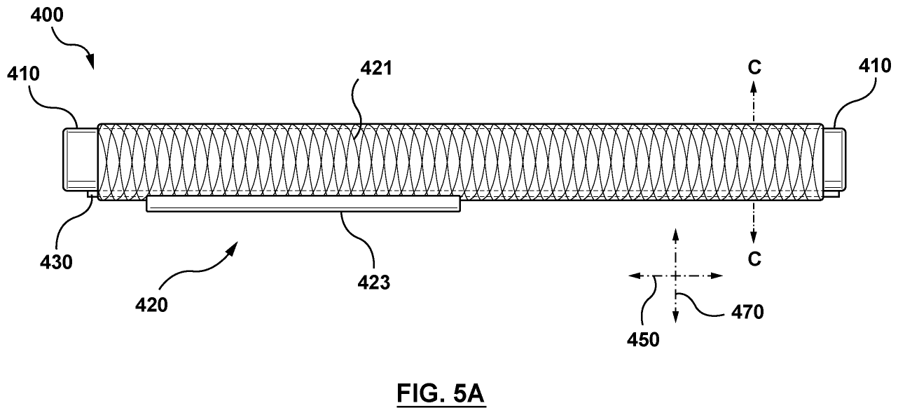

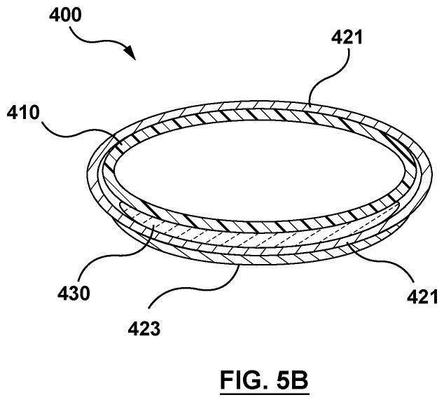

FIGS. 3A-3G depict a haptic actuator 200 that is also an embodiment of the haptic actuator 100. FIG. 3A illustrates a perspective view of the haptic actuator 200, while FIG. 3B illustrates a side view of haptic actuator 200. As depicted in FIGS. 3A and 3B, the haptic actuator 200 includes an elongate bladder 210 (which is an embodiment of the bladder 110), a constraining structure 230 (which may be an embodiment of the constraining structure 130), a coil 221 (which may be an embodiment of the second constraining structure 121 or 131) and a pressure control component 220. In another embodiment, the coil 221 may be replaced by a sleeve. The coil 221 may be part of the pressure control component 220, or may be a passive component that is not part of the pressure control component 220. Various pressure control components are described in more detail with respect to FIGS. 5A through 12. FIG. 3G provides an exploded view of the elongate bladder 210, the coil 221, and the constraining structure 230. As depicted in FIG. 3G, the coil 221 has multiple turns, and may be wrapped around a lateral surface of the elongate bladder 210.

In an embodiment, the elongate bladder 210 of FIGS. 3A-3F may be a sealed tube, which may have a circular cross-section, an elliptical cross-section, or some other cross-section. For instance, as depicted in FIG. 3C, which shows a cross-sectional view of the haptic actuator 200 cut along the line A-A, the elongate bladder 210 may have an elliptical cross section, and may comprise a layer 210c of elastic material that forms a membrane of the elongate bladder 210. The layer 210c of elastic material may enclose a fluid, or a space that can later hold the fluid.

The elongate bladder 210 may have or can be measured along a first dimension 250 and a second dimension 270/260 perpendicular to the first dimension 250. In the embodiment of FIGS. 3A-3F, the first dimension 250 may be a length dimension of the elongate bladder 210, and the second dimension 270/260 may be a radial dimension, a width dimension, or a height dimension of the elongate bladder. The second dimension 270/260 may also be referred to as a perpendicular dimension. In some cases, the first dimension 250 and the second dimension 270/260 may also be referred to as a first axis and a second axis, respectively. If the first dimension 250 is a length dimension of the elongate bladder 210, it may also be referred to as a longitudinal axis of the elongate bladder 210. If the elongate bladder 210 undergoes bending, the axes that define the first dimension 250 and the second dimension 260/270 may be re-oriented to follow the bending of the elongate bladder 210.

In an embodiment, the coil 221 may prevent or otherwise constrain stretching or other expansion of the elongate bladder 210 along the second dimension 260/270. For instance, as depicted in FIG. 3G, the coil 221 has multiple turns and encircles or otherwise surrounds a circumference of the elongate bladder 210, also referred to as surrounding a lateral surface of the elongate bladder 210. In some cases, the coil 221 may have a size (e.g., length) along the first dimension 250 that is substantially the same as a size (e.g., length) of the elongate bladder 210 along the first dimension 250. In an embodiment, the coil 221 may have a high stiffness along a radial dimension of the coil 221, wherein the coil 221 may be aligned with the elongate bladder 210 such that the radial dimension of the coil 221 is a dimension that is parallel with the second dimension 260/270 of the elongate bladder 210. The coil 221 may thus constrain radial expansion of the elongate bladder 210 (i.e., along the perpendicular dimension 270/260). More generally speaking, the coil 221 may constrain expansion along all dimensions that are perpendicular to the first dimension 250. The coil 221 may thus force any expansion of the elongate bladder 210 to occur primarily or solely along the first dimension 250. The coil 221 may also serve to reinforce the elongate bladder 210 against increasing fluid pressure, in order to allow the elongate bladder 210 to operate at high pressure levels for the pressurized fluid therein.

In an embodiment, the layer 210c of elastic material may be stretchable along the first dimension 250 of the elongate bladder 210. The elastic material may include, e.g., an elastomer, such as rubber, or other elastic material. Thus, the elongate bladder 210 can be an elastomer bladder. In an embodiment, the elastic material may be able to withstand a high temperature. For instance, if the coil 221 is a SMA coil that operates at a temperature of up, e.g., to 95° C., the elastic material of the elongate bladder 210 may be able to withstand such a temperature. The elastic nature of the elastic material may also enhance its efficiency.

FIG. 3A further depicts an actuator mount 206 that is attached to a first end 210X of the elongate bladder 210. The actuator mount 206 may be, e.g., a metal rod that attaches the first end 210X of the elongate bladder 210 to another structure, such as a main body of a wearable device, a main body of a handheld controller, or, more generally, to a structure of a user interface device. In an embodiment, the actuator mount 206 may act as another constraining structure that prevents the first end 210X of the elongate bladder 210 from expanding along the first dimension 250. For instance, the actuator mount 206 may be substantially rigid along the first dimension 250. The actuator mount 206 may thus force any expansion of the elongate bladder 210 along the first dimension 250 to occur at a second end 210Y opposite the first end 210X. In other words, the actuator mount 206 may configure the first end 210X of the elongate bladder 210 to act as a fixed end, and to cause any stretching and/or bending of the elongate bladder 210 to occur at the second end 210Y.

In an embodiment, the elongate bladder 210, or more generally the haptic actuator 200, may have a baseline size (i.e., a size before the bladder 210 is deformed) along the first dimension 250 that is in a range of 3 cm to 5 cm. For instance, if the first dimension 250 is a length dimension, the size along the first dimension 250 may refer to a length of the elongate bladder 210. In an embodiment, the elongate bladder 210, or more generally the haptic actuator 200, may have a size along the second dimension 270/260 that is in a range of 0.5 cm to 1.5 cm (e.g., 1 cm).

In an embodiment, with reference to FIG. 3C, when fluid 204 in the elongate bladder 210 increases in pressure, a first surface portion 210a (e.g., top side) of the elongate bladder 210 may be stretched along the first dimension 250, while a second surface portion 210b (e.g., bottom side) opposite the first surface portion 210a may attempt to stretch along the first dimension 250. In an embodiment, the first surface portion 210a and the second portion 210b may be opposite portions of a lateral surface of the elongate bladder 210. That is, the first surface portion 210a and the second surface portion 210b may be diametrically opposed to each other, such that the first surface portion 210a is on one side of the fluid 204, while the second surface portion 210b is on the opposite side of the fluid 204. In the embodiment of FIGS. 3A-3G, the constraining structure 230 is directly attached (e.g., bonded via an adhesive) to the second surface portion 210b, and not to the first surface portion 210a. The constraining structure 230 may be an elongate structure, such as an elongate sheet, which is illustrated in FIGS. 3B, 3C, and 3G. The constraining structure 230 may be a flexible structure, but may be less stretchable along one of its dimensions (e.g., length dimension) than is the elongate bladder 210 along the first dimension 250 thereof. If that dimension of the constraining structure is aligned with the first dimension 250 of the elongate bladder 210, then the constraining structure 230 may also be characterized as being less stretchable along the first dimension 250 than is the elongate bladder 210 along the first dimension 250. The bonding or other direct attachment between the constraining structure 230 and the second surface portion 210b of the elongate bladder 210 may constrain the second surface portion 210b from stretching (e.g., lengthening) along the first dimension.

As stated above, a pressure control component 220 may, when activated, be configured to increase fluid pressure of a fluid in the elongate bladder 210, such that the fluid exerts more pressure against the layer 210c of the elongate bladder 210. Pressure control components are described below in more detail. For instance, the pressure control component 220 may include the coil 221 and may be configured to cause the coil 221 to shrink along its radial dimension, wherein the radial dimension is a dimension parallel with the second dimension 270/260 of the elongate bladder 210, thereby squeezing or otherwise compressing the elongate bladder 210 along the second dimension 270/260 thereof.

FIGS. 3D and 3E illustrate the stretching of the elongate bladder 210 due to an increase in fluid pressure. More specifically, FIG. 3D provides a sectional view of the elongate bladder 210 and of the coil 221 cut along the line B-B of FIG. 3A. The coil 221 may channel the increase in the fluid pressure into expansion of the elongate bladder 220 along the first dimension 250 (rather than along the second dimension 270/260). FIG. 3D depicts expansion of the elongate bladder 210 without the presence of the constraining structure 230. More specifically, the figure illustrates that, when pressure of the fluid in the elongate bladder 210 increases and the coil 221 prevents radial expansion of the elongate bladder 210, the pressure increase may cause expansion or stretching of the elongate bladder 210 along the first dimension 250 such that a size (e.g., length) of the elongate bladder along that dimension increases from a length L₁ to a length L₂. As stated above, the actuator mount 206 may configure the first end 210X of the elongate bladder 210 to act as a fixed end, and thus may cause the length increase to occur at the second end 210Y of the elongate bladder 210.

FIG. 3E depicts the expansion of the elongate bladder 210 when a constraining structure 230 is utilized. More specifically, the constraining structure 230 causes the first surface portion 210a of the elongate bladder 210 to stretch along the first dimension 250 by a greater amount than the second surface portion 210b. As illustrated in FIG. 3E, the first dimension 250 and the second dimension 270 (dimension 260 is omitted for purposes of clarity) may be re-oriented to follow the bending of the elongate bladder 210. In an embodiment, the first dimension 250 may refer to a reference axis that is tangent to or otherwise parallel with a surface of an end portion 210c_{end} of the layer 210c, wherein the end portion 210c_{end} is a portion of the layer 210c that is being stretched. The second dimension 270/260 continues to be perpendicular to the first dimension 250. The end portion 210c_{end} may be the same as the second end 210Y.

As depicted in FIG. 3E, before the elongate bladder 210 is stretched, the first surface portion 210a and the second surface portion 210b may both have a baseline size (e.g., length) of L₁ along the first dimension 250. When the fluid pressure within the elongate bladder 210 increases, the pressure increase may stretch the first surface portion 210a, at the second end 210Y of the elongate bladder 210, from a baseline size of L₁ to a stretched size of La₂. The pressure increase may attempt to stretch the second surface portion 210b of the elongate bladder 210, but the constraining structure 230 may limit any stretching to a stretched size of L_{b2}. In an embodiment, the constraining structure 230 may substantially prevent stretching of the second surface portion 210b of the elongate bladder, such that L_{b2} remains substantially equal to L₁. As a result, the first surface portion 210a and the second surface portion 210b of the elongate bladder 210 may experience different amounts of stretching, which may generate a force F that bends the elongate bladder 210 at the second end 210Y thereof, as illustrated in FIG. 3E.

In an embodiment, the haptic actuator 200 may be able to control a degree of bending thereof. For instance, FIG. 3F illustrates the elongate bladder 210 of the haptic actuator 200 having different states 202a through 202e that reflect different degrees of bending, in an ascending order (from no bending to most bending). In an embodiment, the degree of bending may be controlled by controlling an amount of pressure increase of a fluid contained within the elongate bladder 210. Different amounts of pressure increases may lead to different amounts of stretching of the first surface portion 210a of the elongate bladder 210, wherein more stretching may lead to more bending of the elongate bladder 210. In FIG. 3F, state 202e may correspond to a degree of bending in which the first surface portion 210a of the elongate bladder has been stretched to a size Lₐ₂. The state 202d may correspond to a degree of bending in which the first surface portion 210a has been stretched to a size La₃, while the state 202c may correspond to a degree of bending in which the first surface portion 210a has been stretched to a size Lₐ₄, and the state 202b may correspond to a degree of bending in which the first surface portion 210a has been stretched to a size Lₐ₅. The state 202a may correspond to a state in which the elongate bladder 210 is unbent, and the first surface portion 210a of the elongate bladder 210 has a baseline size of L₁.

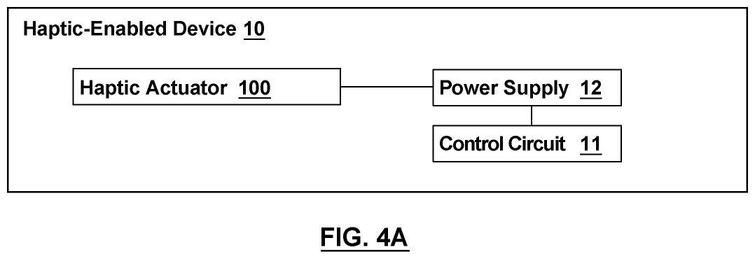

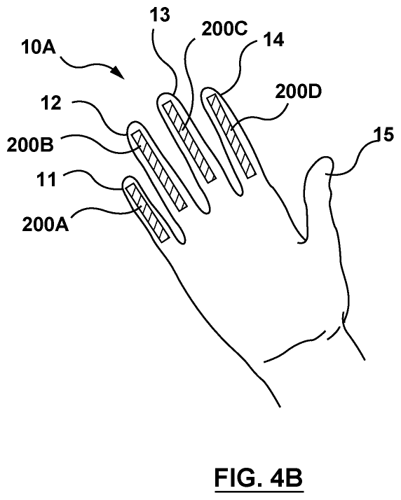

FIG. 4A illustrates an embodiment of a haptic-enabled device 10 that includes a haptic actuator 100. In an embodiment, the haptic-enabled device 10 may be a handheld game controller having a joystick, trigger, or other moveable user input component. In an embodiment, the haptic-enabled device 10 may be a mobile phone having an actuatable component, which may be actuatable by the haptic actuator 100. In an embodiment, the haptic-enabled device 10 may be a wearable device. The haptic-enabled device 10 may further include a power supply 12 (e.g., a battery) and a control circuit 11. The power supply may be able to provide power to the haptic actuator 100, such as to a pressure control component 120 of the haptic actuator 100. The control circuit 11 may be configured to control when the haptic actuator 100 and the pressure control component 120 thereof is activated, by controlling when power is delivered from the power supply 12 to the haptic actuator 100. In an embodiment, the control circuit 11 may be dedicated to controlling haptic functionality on the haptic-enabled device 10, or may be a more general purpose control circuit 11. In an embodiment, the haptic control circuit 11 may include a microprocessor, an application-specific integrated circuit (ASIC), a field programmable gate array (FPGA), a programmable logic array (PLA), or any other control circuit 11.

FIG. 4B depicts a haptic-enabled glove 10A that is an embodiment of the haptic-enabled device 10. In an embodiment, the haptic-enabled glove 10A may include one or more motion sensors that are configured to sense movement of a hand of a user wearing the haptic-enabled glove. The haptic-enabled glove 10A may be configured to wirelessly communicate signals from the one or more motion sensors to a computer executing an application, which may receive the signals as user input.

In an embodiment, the haptic-enabled glove 10A may include haptic actuators 200A-200D, each of which may be an embodiment of the haptic actuator 100 and of the haptic actuator 200. The haptic-enabled glove 10A may include finger sheaths 11-15 for a user's fingers, and each of the haptic actuators 200A-200D may be attached on or embedded inside one of the finger sheaths 11-15. Further, each of the haptic actuators 200A-200D may have an elongate structure that is oriented along a length dimension of the respective finger sheath to which it is attached. When one of the haptic actuators 200A-200D is activated, it may be configured to exert a bending force on the finger sheath to which it is attached, and on a finger inside the finger sheath. In an embodiment, each of the haptic actuators 200A-200D may be able to generate an acceleration that is in a range of 1.6 g to 4.5 g, and a displacement that is in a range of 14 mm to 25 mm.

In an embodiment, as stated above, a pressure control component 120 or a compressing apparatus 120A may rely on a SMA component. FIGS. 5A and 5B depict a haptic actuator 400 that has a pressure control component 420 that includes a SMA coil 421 (which may be an embodiment of the coil 221) and a heating device 423. FIG. 5A illustrates a side view of the haptic actuator 400, while FIG. 5B illustrates a cross-sectional view of the haptic actuator 400 cut along the line C-C in FIG. 5A. More specifically, the haptic actuator 400 includes an elongate bladder 410 and a constraining structure 430 directly attached to a first surface portion of the elongate bladder 410. In the embodiment of FIG. 5A, the constraining structure is not in direct contact with nor directly attached to a second surface portion that is diametrically opposed to the first surface portion. The elongate bladder 410 may have or be measured along a first dimension 450 and a second dimension 470 (also called a perpendicular dimension) perpendicular to the first dimension 450. The elongate bladder 410 and the constraining structure 430 may be embodiments of, e.g., the elongate bladder 210 and the constraining structure 230, respectively. In an embodiment, the elongate bladder 410 and the constraining structure 430 may be wrapped with a SMA coil 421, which may be a fiber (also referred to as a filament) of SMA material that is wrapped around a lateral surface of the elongate bladder 410 and the constraining structure 430. Examples of the SMA material, which may be a resilient material, include a copper-aluminum-nickel alloy, a nickel-titanium alloy, and a copper-zinc-aluminum-nickel alloy.

In an embodiment, the SMA coil 421 may have fabricated with a step that applied a thermomechanical treatment to the SMA coil 421. The thermomechanical treatment may have included deformation of the material of the SMA coil 421 into a desired shape, namely that of a coil, as well as heat treatment of the material. The thermomechanical treatment may have imparted a shape memory or mechanical memory to the material of the SMA coil, so that it reverts to the coil shape or to any other trained shape when a stimulus is applied to the material. In other words, the SMA coil 421 may exhibit a shape memory effect in which it reverts or otherwise changes to a coiled shape (which may be referred to as a trained shape) when a thermal stimulus or other stimulus is applied to a material of the SMA coil.

In an embodiment, the shape change for the SMA coil may be associated with a transition between a martensite phase and an austenite phase. More specifically, the SMA coil 421 may have a martensite phase in which the SMA coil 421 is at a relatively low temperature, which may be a temperature below a first threshold temperature. In an embodiment, the martensite phase may be associated with temperatures that are substantially equal to or lower than an ambient temperature (e.g., 20° C.). The SMA coil 421 may further have an austenite phase in which the SMA coil 421 is at a relatively high temperature (e.g., 40° C. or 95° C.), which may be a temperature above a second threshold temperature. In an embodiment, the austenite phase may be associated with temperatures that are higher than the ambient temperature. The heating device 423 may be configured to control whether the SMA coil 421 is in the martensite phase or is in austenite phase, and may be configured to cause the SMA coil 421 to transition between the two phases. In an embodiment, the heating device 423 may be, e.g., a low-resistance resistor, a Peltier device, or some other device.

In an embodiment, the SMA coil 421 may exhibit a two-way shape memory effect, in which a material of the SMA coil 421 was trained by the thermomechanical treatment to revert to or otherwise have a first shape in the martensite phase, and to revert to or otherwise have a second shape in the austenite phase. The first shape may be a first coil having a first radius, while the second shape may be a second coil having a second radius, wherein the second radius is smaller than the first radius. In this example, the heating device 423 may heat the SMA coil 421 so as to cause the SMA coil to transition from its martensite phase to its austenite phase. The transition may cause the SMA coil 421 to transition from the first shape to the second shape. Because the first shape and the second shape are both coils, and because the second shape involves a coil with a smaller radius, the shape change from the first shape to the second shape may effectively cause the SMA coil 421 to shrink in radius. The shrinking that results from the shape change may compress the elongate bladder 410 and the fluid therewithin.

In an embodiment, the haptic actuator may rely solely on natural cooling for the SMA component to return to an ambient temperature. In an embodiment, the haptic actuator may include a cooling component, such as a Peltier device, that is able to cool the SMA component at a faster rate. For instance, the heating device 423 may also be a Peltier device, or the haptic actuator 400 may include a Peltier device in addition to the heating device 423. In an embodiment, the fluid in the elongate bladder 410 may include a coolant.

In an embodiment, the heating device 423 may be a device configured to cause the SMA coil to transition from a martensite phase to an austenite phase by applying heat to increase a temperature of the SMA coil. This transition may involve the SMA coil 421 changing shape to a coil having a smaller radius relative to its current radius. Thus, the coil 421 may squeeze or otherwise compress the elongate bladder 410 along the dimension 470. The compression may reduce a size of the elongate bladder 410 along the dimension 470, which may reduce a volume within the bladder 410 and increase a fluid pressure within the elongate bladder 410. The pressure increase may occur on the order of milliseconds (e.g., 5 milliseconds), or may occur over a longer time scale (e.g., seconds). As stated above, the SMA coil 421 may also serve as a constraining structure that channels the pressure increase to expansion of the elongate bladder 410 along the first dimension 450.

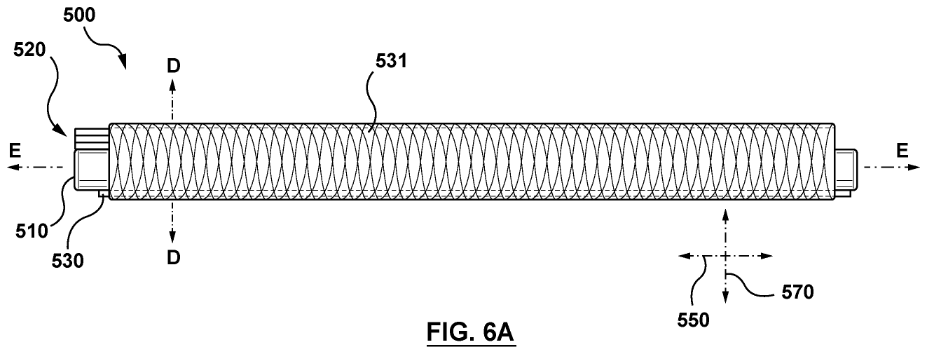

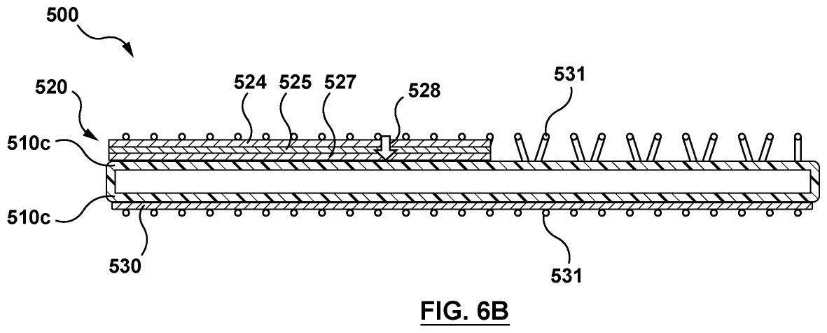

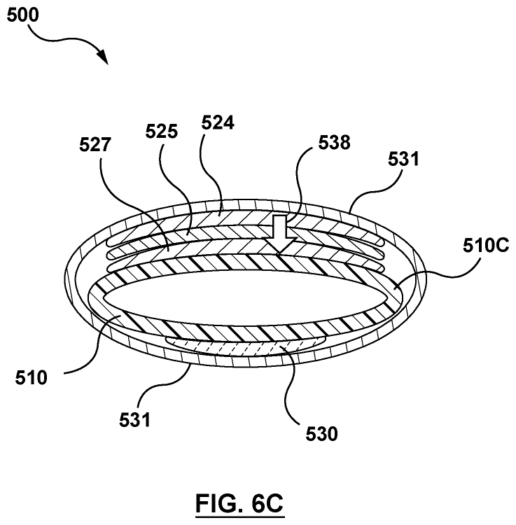

As stated above, the pressure control component 120 may rely on the use of an EAP component, such as a component having PVDF. FIGS. 6A-6C depicts an embodiment of a haptic actuator 500 (which may be an embodiment of haptic actuator 100) that uses a layer of EAP material. FIG. 6A depicts a side view of the haptic actuator 500, which may include an elongate bladder 510, a constraining structure 530 directly attached to the elongate bladder 510, a pressure control component 520, and a coil 531. The coil 531 may serve as another constraining structure, similar to the coils 221, 421. In another embodiment, the coil 531 may be replaced by a sleeve. In the embodiment of FIGS. 6A-6C, the coil 531 may be a passive component formed from a fiber (also referred to as a filament) of, e.g., iron, copper, or plastic (or other non-SMA material), and is not an active element of the pressure control component 520. In an embodiment, the coil 531 may be a SMA coil, and may be considered part of the pressure control component 520.

FIG. 6B illustrates a sectional view of the haptic actuator 500 cut along a line E-E of FIG. 6A, while FIG. 6C illustrates a sectional view of the haptic actuator 500 cut along a line D-D of FIG. 6A. As depicted in FIGS. 6B and 6C, the pressure control component 520 may be a compressing apparatus that includes a layer 525 of EAP material, which is configured to expand in thickness or otherwise deform in the presence of an external electric field having a first polarity (the EAP material may be configured to contract in thickness in the presence of an external electric field having a second and opposite polarity). For instance, the layer 525 of EAP material, such as PVDF, may be able to exhibit a strain of about 8% in the presence of an external electric field. The expansion or other deformation may be aligned with an axis of the electric field. In an embodiment, the pressure control component 520 may be adjacent to and in contact with the elongate bladder 510, so that the elongate bladder 510 can be compressed by the pressure control component 520. As depicted in FIG. 6A, the elongate bladder 610 may have or be measured along a first dimension 550 (e.g., a length dimension) and a second dimension 570 perpendicular to the first dimension 550. The pressure control component 520 may be configured to compress the bladder 610 along the second dimension 570.

In an embodiment, the pressure control component 520 may further include at least two electrodes 524, 527 disposed on opposite sides of the layer 525 of EAP material. The at least two electrodes 524, 527 may be oriented so that, when a voltage difference is created between the at least two electrodes 524, 527, they will create an external electric field that is oriented along the second dimension 570 (e.g., width dimension, height dimension, or radial dimension) of the elongate bladder 510. As a result, when a voltage difference of a first polarity is created between the at least two electrodes 524, 527, the layer 525 of EAP material may expand in thickness along the second dimension 570. In an embodiment, the haptic actuator 500 may be configured to apply a voltage difference having a first polarity and that is in a range of 10 V to 200 V to the layer 525 of EAP material.

In an embodiment, when the layer 525 of EAP material is expanding, the coil 531 may channel the expansion toward the elongate bladder 510, or more specifically toward a layer 510c forming the membrane of the elongate bladder 510. More specifically, the coil 531 is a constraining structure that resists outward or radial expansion by the bladder 510. When the coil 531 is wrapped around a lateral surface of the elongate bladder 510, as illustrated in FIG. 6A, the radial dimension of the coil 531 may be parallel with the second dimension 570. Thus, when the layer 525 of EAP material expands and presses against the coil 531, the coil 531 may act as a substantially immovable structure that blocks expansion in the direction that is from the layer 525 to the coil 531. Thus, the layer 525 of EAP material may be forced to expand away from the coil 531, and inwardly, toward the elongate bladder 510. As the layer 525 of EAP material expands radially inward, the layer 525 may begin to press on the elongate bladder 510. Thus, the expansion of the layer 525 may generate a force 528 that compresses the elongate bladder 510. The compression may increase fluid pressure within the elongate bladder 510, which may be channeled by the coil 531 to cause the elongate bladder 510 to stretch along the first dimension 550. In an embodiment, the constraining structure 530 may be configured to cause the elongate bladder 510 to bend, as described above with respect to FIGS. 3A-3F.

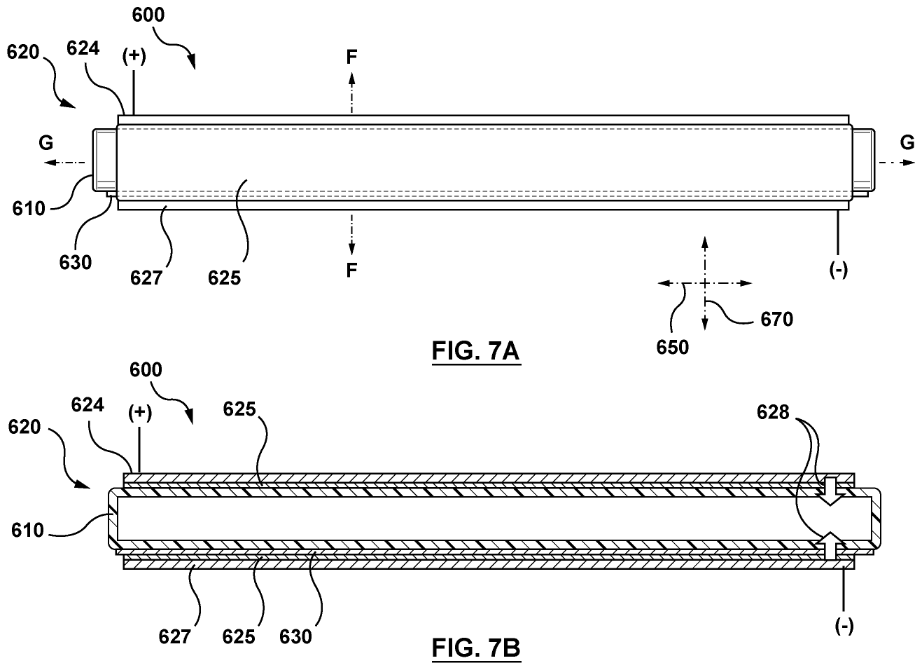

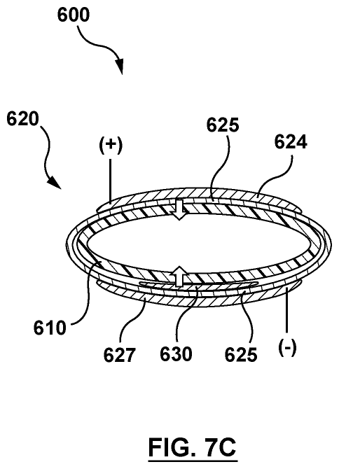

In an embodiment, as stated above, the pressure control component 120 may rely on an EAP component that uses a dielectric elastomer material. For instance, FIGS. 7A-7C depict a pressure control component 620 that uses a dielectric elastomer material. The pressure control component 620 is part of a haptic actuator 600 that may be an embodiment of the haptic actuator 100/200. The haptic actuator 600 includes an elongate bladder 610, a constraining structure 630 directly attached to the elongate bladder 610, and the pressure control component 620. The elongate bladder 610 may have a first dimension 650 (e.g., length dimension) and a second dimension 670 perpendicular to the first dimension. In an embodiment, the haptic actuator 620 may omit the presence of a coil, such as coil 531. In another embodiment, the haptic actuator 620 may include such a coil.

As depicted in FIG. 7B, which is a sectional view of the haptic actuator 600 cut along a line G-G of FIG. 7A, and as depicted in FIG. 7C, which is a cross-sectional view of the haptic actuator 600 cut along a line F-F of FIG. 7A, the pressure control component 620 includes a layer 625 of dielectric elastomer material, and at least two electrodes 624, 627. As illustrated in FIG. 7C, the layer 625 of dielectric elastomer material may wrap around or otherwise surround the elongate bladder 610 and the constraining structure 630. In an embodiment, the dielectric elastomer material of layer 625 may be silicone or another elastomer material.

In an embodiment, the two electrodes 624, 627 may be disposed on opposite surface portions of the elongate bladder 610 and may both be directly attached to the layer 625 of dielectric elastomer material. In an embodiment, the haptic actuator 600 may be configured to create a voltage difference between the two electrodes 624, 627, such as a voltage in a range of 500 V to 5 kV. The voltage difference may create an electrostatic attraction between the two electrodes 624, 627, which may generate a force 628 that draws or attracts the two electrodes 624, 627 toward each other. This force may squeeze or otherwise compress the elongate bladder 610, as well as the layer 625 of dielectric elastomer material. In an embodiment, the layer 625 of dielectric elastomer may be able to undergo a strain of up to 30% along the second dimension 670 when the voltage difference is created. The compression from the force which may cause an increase in a pressure of a fluid in the elongate bladder 610. The force that is squeezing or otherwise compressing the elongate bladder 610 may be aligned with the second dimension 670 of the elongate bladder 610, and thus may act as a constraint that prevents expansion of the elongate bladder along the second dimension 670. This constraint may thus force any expansion of the elongate bladder 610 to occur along the first dimension 650. Further, the constraining structure 630 may cause uneven amounts of stretching on opposite surface portions of the elongate bladder 610, which may cause the elongate bladder 610 to bend.

FIGS. 7A-7C illustrate an embodiment in which the constraining structure 630 is directly attached to the elongate bladder 610, such that they are in contact with each other. In another embodiment, the constraining structure may be directly attached to one of the electrodes 624, 627, and the electrode 624/627 may be disposed between the constraining structure 630 and the elongate bladder 610. In such an embodiment, the constraining structure 630 may be configured to indirectly constrain stretching of the elongate bladder 610, by directly constraining stretching of an electrode 624/627 that is in turn bonded to the elongate bladder 610.

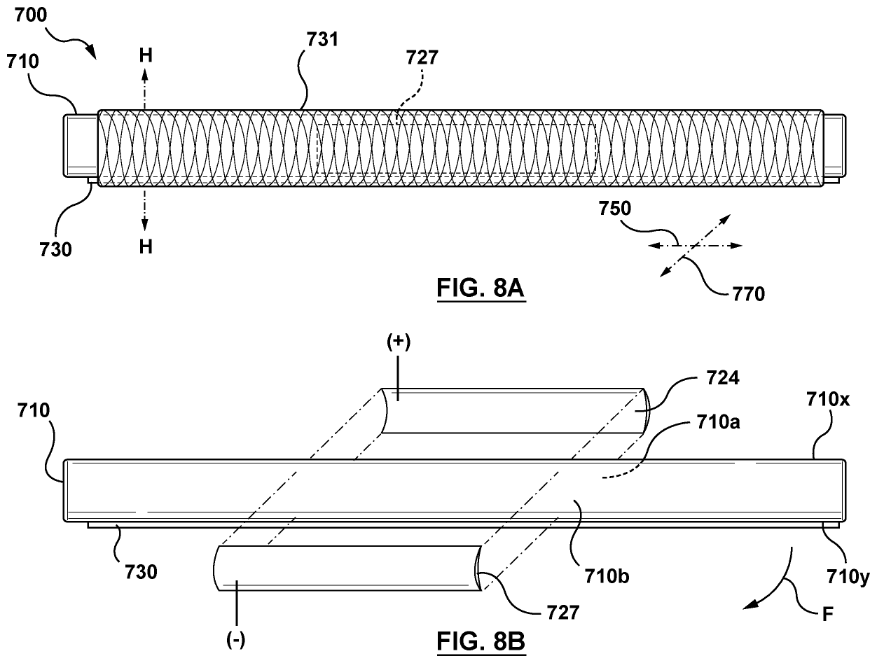

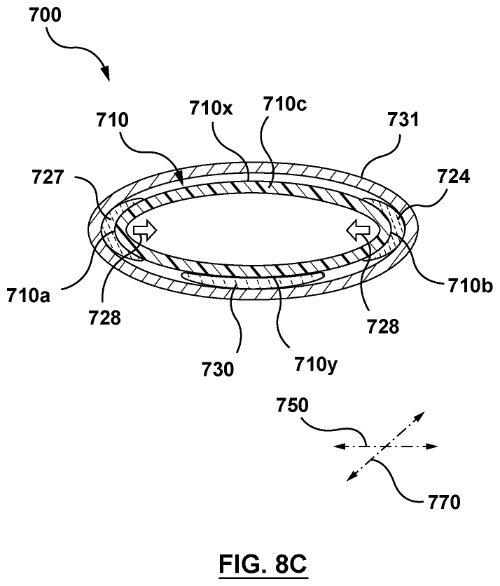

In an embodiment, as stated above, a bladder (e.g., 110) of a haptic actuator (e.g., 100) may be formed from an EAP material. Such an embodiment may allow the material of the bladder itself to actively compress a fluid within the bladder in order to increase fluid pressure. In other words, it may configure the bladder 110 as an active bladder. For instance, FIGS. 8A-8C depict a haptic actuator 700 (which may be an embodiment of the haptic actuator 100/200) that includes an elongate bladder 710 that is formed from a layer 710c of EAP material (illustrated in FIG. 8C), such as PVDF or silicone. The elongate bladder 710 may be measured along a length dimension 750 and a perpendicular dimension 770 thereof. FIG. 8A illustrates a side view of the haptic actuator 700, which includes the elongate bladder 710, a constraining structure 730 attached to the elongate bladder, and a coil 731 wrapped around the elongate bladder 710 and the constraining structure 730. In an embodiment, the coil 731 may act as another constraining structure that is configured to resist radial expansion, and thus resists expansion of the elongate bladder 710 along the perpendicular dimension 770.

FIG. 8B illustrates a partially exploded view of the components of the haptic actuator 700 with the coil 731 removed. More specifically, FIG. 8B illustrates a first electrode 724 disposed on a first surface portion 710a of the elongate bladder 710, and a second electrode 727 disposed on a second surface portion 710b of the elongate bladder 710, wherein the first surface portion 710a (e.g., left side) and the second surface portion 710b (e.g., right side) are opposite surface portions of the elongate bladder 710. As illustrated in FIG. 8C, which is a cross-sectional view of the haptic actuator 700 taken along a line H-H of FIG. 8A, the electrodes 724, 727 do not overlap with the constraining structure 730. In another embodiment, the electrodes 724, 727 may overlap with the constraining structure 730. For instance, one of the electrodes 724, 727 may be disposed at a location that is directly between the elongate bladder 710 and the constraining structure 730.

In an embodiment, a voltage difference may be created between the first electrode 724 and the second electrode 727 in order to activate the layer 710c of EAP material. For instance, the voltage difference may cause an expansion, such as an increase in thickness, of the layer 710c of EAP material. Because the coil 731 resists expansion along radial dimension 770, it may prevent expansion of the layer 710c in a direction that is outward or otherwise toward the coil 731. Thus, the layer 710c may be forced to expand in an inward direction that is away from the coil 731, and that is toward an interior of the elongate bladder 710. The expansion in the inward direction may create a force 728 (see FIG. 8C) exerted by the layer 710c on a fluid within the elongate bladder 710. The force 728 may increase a pressure exerted by the fluid on the layer 710c. The coil 731 may channel the increase in pressure into stretching of the elongate bladder 710 along the length dimension 750 thereof. The constraining structure 730 may cause different amounts of stretching between a third surface portion 710x (e.g., top side) and a fourth surface portion 710y (e.g., bottom side) of the elongate bladder 710, which may create a force F (FIG. 8B) that bends the elongate bladder 710 toward, e.g., the fourth surface portion 710y. In the above example, the fourth surface portion 710y may be a portion of a lateral surface of the elongate bladder 710 that is directly attached to the constraining structure 730, while the third surface portion 710x may be diametrically opposed to the fourth surface portion 710x. In another embodiment, the layer 710c may be configured to directly bend in response to a voltage signal being applied to the layer 710c, even without compressing a fluid within the bladder 710. Thus, in some instances, such an embodiment may omit the presence of the fluid in the bladder 810.

In an embodiment, the elongate bladder 710 may replace the layer 710c of EAP material with a layer of material having shape memory and formed from a shape memory polymer (SMP). The layer of SMP may exhibit the shape memory effect, which is discussed above. The layer of SMP may have been processed with a thermomechanical treatment that causes the layer of SMP to retain a shape memory, such that the SMP reverts to a trained shape in response to heat or some other stimulus. In such an embodiment, the electrodes 724, 727 may still be used to stimulate the layer of SMP to trigger a transition of the layer of SMP from a first shape to a second shape. Alternatively, the electrodes 724, 7247 may be replaced and/or augmented by another stimulation device, such as a heating device or light source (e.g., infrared light source) that is configured to stimulate the layer of SMP to trigger the transition from the first shape to the second shape. In an embodiment, the layer of SMP may shrink when it transitions from the first shape to the second shape, which may generate a compressive force that increases fluid pressure within the elongate bladder 710. In an embodiment, the SMP may include a linear block copolymer, such as polyurethane or poly(ether-ester), or a thermoplastic polymer such as polyester.

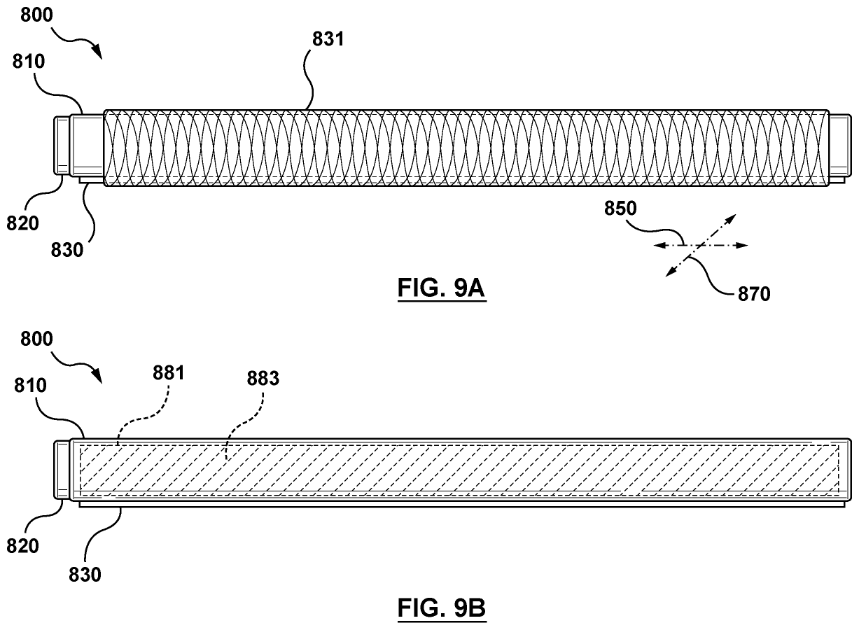

In an embodiment, as stated above, a pressure control component 120 may rely on stimulating expansion of a hydrogel. For instance, FIGS. 9A and 9B illustrate a haptic actuator 800 (which may be an embodiment of haptic actuator 100/200) having a hydrogel stimulation apparatus 820. The haptic actuator 800 further includes an elongate bladder 810 and a constraining structure 830 attached to the elongate bladder 810, and a coil 831 wrapped around the elongate bladder 810 and the constraining structure 830. The elongate bladder 810 may have a length dimension 850 and a perpendicular dimension 870. FIG. 9B illustrates components of the haptic actuator 800 with the coil 831 removed. More specifically, FIG. 9B depicts the elongate bladder 810 enclosing a fluid 881 that includes a hydrogel 883.

In an embodiment, the hydrogel 883 may be formed from a hydrophilic polymer, and may have an activated state in which a polymer network of the hydrogel 883 absorbs water and swells, or more generally expands, in volume. In an embodiment, the increase in volume may be, e.g., 2 to 10 times that of a baseline volume, wherein the baseline volume is a volume in which the hydrogel 883 has not expanded. Examples of the hydrogel 883 include an ionic hydrogel, a dendrimer-based hydrogel, an acrylamide-based (e.g., Poly(N-isopropylacrylamide)) hydrogel, a poloxamer-based hydrogel, a polyvinyl chloride (PVC) based hydrogel, a polythiophene-based hydrogel, a carbazole-based (e.g., poly (N-vinyl carbazole)) hydrogel. The hydrogel 883 may be activated from a non-hydrophilic state to a hydrophilic state based on an electrical stimulus (e.g., the presence of an electric field), a magnetic stimulus (e.g., presence of a magnetic field), a chemical stimulus (e.g., a change in pH), a thermal stimulus (e.g., a change in temperature), or a light stimulus, wherein light refers to visible light, infrared radiation, or ultraviolet radiation.

In an embodiment, the hydrogel stimulation apparatus 820 is an embodiment of the pressure control component 120. The hydrogel stimulation apparatus 820 may be a device or mechanism configured to provide at least one of an electrical stimulus, a magnetic stimulus, a chemical stimulus (e.g., to alter a pH or ionic strength of the hydrogel), a thermal stimulus, or a light stimulus to the hydrogel 883. For instance, the hydrogel stimulation apparatus 820 may include at least one of an electromagnet, an electrode, a heating device, or a light source (e.g., ultraviolet (UV) light source). In an embodiment, the hydrogel may be an ionic hydrogel, and the hydrogel stimulation apparatus 820 may be a UV light source configured to apply ultraviolet radiation to the ionic hydrogel. The stimulus from the hydrogel stimulation apparatus 820 may cause the hydrogel 883 to begin absorbing water and expanding in volume.

In an embodiment, once the hydrogel 883 is activated and expands, the coil 831 may be configured to prevent expansion of the hydrogel 883 along the perpendicular dimension 870 of the elongate bladder 810. Thus, the hydrogel 883 may be forced to expand along the length dimension 850 of the elongate bladder 810, which may stretch the elongate bladder 810 along the length dimension 850 thereof. The constraining structure 830 may cause different amounts of stretching between two opposite surface portions (e.g., opposite sides) of the elongate bladder 810, which may cause bending of the elongate bladder 810.

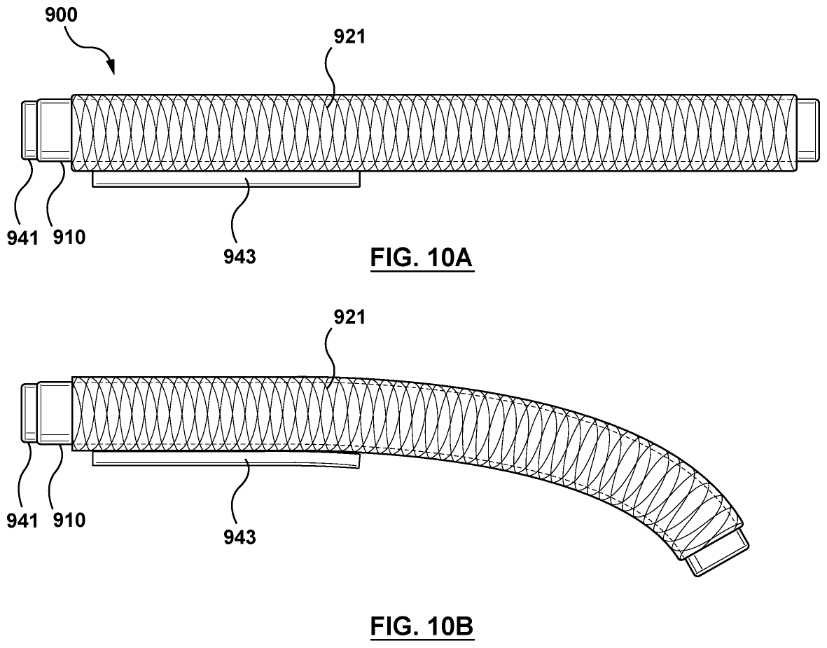

FIGS. 10A and 10B illustrate a haptic actuator 900 that combines the use of a SMA material with a SMP. In some cases, the SMA material may be able to provide a high amount of force, but a low amount of deformation, while the SMP may be able to provide a high amount of deformation, but a low amount of force. Thus, the combination of the SMA material and the SMP may be advantageous as complementing each other by providing both a high amount of force and a high amount of deformation when used together. In an embodiment, the haptic actuator 900 includes an elongate bladder 910 formed from a SMP, a SMA coil 921 formed from the SMA material, and a heating device 943 for activating the SMA material, as well as a SMP stimulation apparatus 941 for activating the SMP. In an embodiment, the SMP may include a linear block copolymer, such as polyurethane or poly(ester-ester), or a thermoplastic polymer such as polyester.

In an embodiment, the SMP and the SMA may both be configured to exhibit a one-way shape memory effect. For instance, the SMP that forms the elongate bladder 910 may be configured, when activated, to revert to a trained shape, such as a bent shape. More generally speaking, the SMP may be configured to transition from a first shape that is an unbent shape to a second shape that is a bent shape. FIG. 10A illustrates the first shape of the elongate bladder 910, while FIG. 10B illustrates the second shape of the elongate bladder. More specifically, because the elongate bladder 910 is made from a SMP, which may be been processed with a thermomechanical treatment to impart a bent shape as part of the shape memory of the SMP. Thus, when the SMP is heated or otherwise activated, it may have a bent shape. In an embodiment, the bent shape may be associated with a programmed state of the SMP, while the unbent shape may be referred to a recovered state of the SMP. The recovered state may be a lower-entropy state, while the programmed state may refer to a higher-entropy state. Thus, heat or other stimulus may trigger a transition of the SMP from the recovered state to the programmed state, which may cause the SMP to change shape from the unbent shape to the bent shape. In an embodiment, the transition does not need to involve changes in fluid pressure. Thus, the haptic actuator 900 of FIGS. 10A and 10B may be operated without filling the elongate bladder 910 with a fluid.

In an embodiment, the SMP stimulation apparatus 941 may include an electrode, an electromagnet, a heating device, or a light source. The SMP stimulation apparatus 941 may be configured to apply an electrical stimulus, a magnetic stimulus, a thermal stimulus, or a light stimulus to cause the elongate bladder 910 to transition from the first shape to the second shape.

As illustrated in FIGS. 10A and 10B, the haptic actuator 900 may generate a bending deformation when the elongate bladder 910 transitions from the first shape to the second shape. In an embodiment, the SMA coil 921 may be configured to reset the haptic actuator 900 by returning the elongate bladder 910 to the first shape. More specifically, the SMA coil 921 may be made of a SMA material that was processed to revert or otherwise change to a trained shape when the SMA material is activated. The trained shape may be associated with an austenite phase of the SMA material, which may be triggered by heating the SMA material, or may be associated with a martensite phase of the SMA material, which may be triggered by cooling the SMA material (e.g., via a Peltier device). In an embodiment, the SMP may transition from its recovered state to its programmed state in response to heat, while the SMA may revert to its trained state when the SMA is cooled so as to transition to its martensite phase. In an embodiment, the trained shape of the SMA may be that of an unbent coil. This transition may also force the elongate bladder 910 to the unbent coil shape.

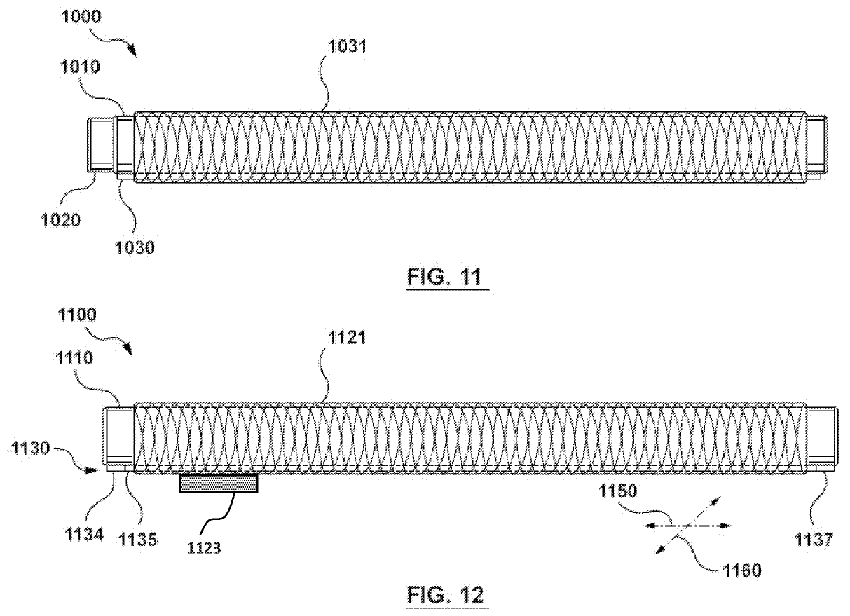

FIG. 11 illustrates a haptic actuator 1000 (which may be an embodiment of the haptic actuator 100) that uses a pump 1020 (which may be an embodiment of the pressure control component 120) that is a pneumatic or hydraulic pump. The pump 1020 may be combined with the smart material components described above, or may replace the use of such smart material components. In an embodiment, the haptic actuator includes an elongate bladder 1010, a constraining structure 1030 attached to the elongate bladder 1010, the pump 1020, and a coil 1031 wrapped around the elongate bladder 1010 and the constraining structure 1030. To generate a bending deformation, the pump 1020 may, e.g., pump additional fluid into the elongate bladder 1010, in order to increase pressure of the fluid within the elongate bladder 1010. The increased pressure may cause the elongate bladder 1010 to stretch along a length dimension thereof. The constraining structure 1030 may cause uneven amounts of stretching on two opposite surface portions of the elongate bladder 1010, which may cause the elongate bladder 1010 to bend.

FIG. 12 depicts a haptic actuator 1100 having a constraining structure 1130 that comprises a layer 1135 of EAP material. More specifically, the haptic actuator 1100 includes an elongate bladder 1110, the constraining structure 1130 attached to the elongate bladder 1110, a coil 1121 wrapped around the elongate bladder 1110 and the constraining structure 1130, and a heating device 1123. In an embodiment, the elongate bladder 1110 may have a length dimension 1150 and a perpendicular dimension 1160. In an embodiment, the coil 1121 may be a SMA coil. The SMA coil and the heating device 1123 may be part of a pressure control component that is configured to compress the elongate bladder 1110 along the perpendicular dimension 1160 in order to increase a pressure of a fluid within the elongate bladder 1110.

In the embodiment of FIG. 12, the constraining structure 1130 may include a layer 1135 of EAP material and two electrodes 1134, 1137 disposed at and electrically connected to opposite ends of the layer 1135. The layer 1135 of EAP material may be similar to the layer 525 of EAP material in FIGS. 6A-6C, and may be directly attached (or indirectly attached) to the elongate bladder 1110. The layer 1135 of EAP material may be configured to shrink or otherwise contract along the length dimension 1150 of the elongate bladder 1110 when a voltage difference is created between the electrodes 1134, 1137. Thus, when the voltage difference is created, the layer 1135 may not only constrain stretching of one side (e.g., bottom side) of the elongate bladder 1110, but further provide a contracting force that forces that side of the elongate bladder 1110 to contract along the length dimension 1150. Meanwhile, the opposite side (e.g., top side) of the elongate bladder 1110 is not constrained, and thus expands along the length dimension. Thus, the layer 1135 of EAP material may even cause one side of the elongate bladder 1110 to contract along the length dimension 1150 while an opposite side of the elongate bladder 1110 expands along the length dimension 1150. Such a difference in change of size between the two sides of the elongate bladder 1110 may generate more bending compared to the embodiments described above. The electrodes and heating device described in this embodiment or in any other embodiment may be controlled by a control circuit, such as control circuit 11.

In an embodiment, one or more of the above elongate bladders (e.g., elongate bladder 410) may have at least one hinge (e.g., a living hinge) that is formed on a surface of the elongate bladder. The hinge may facilitate bending and unbending of the elongate bladder along the hinge. In some instances, the hinge may be formed from a slight inward indentation on the surface of the elongate bladder. When a pressure of a fluid within the elongate bladder increases, the pressure increase may be an outward pressure on the surface of the elongate bladder. In some cases, the outward pressure may tend to make the surface of the elongate bladder more uniform, and may reduce or eliminate the inward indentation of the hinge. Thus, the increase in the pressure of the fluid may not only bend the elongate bladder, as described in the above embodiments, but may also eliminate the hinge. As a result, the elongate bladder may be more difficult to unbend, because the hinge has been eliminated. This condition may remain so long as the pressure of the fluid within the bladder is at the increased value. This result may act to lock a deformation of the elongate bladder in place. In other words, it may facilitate locking the elongate bladder into a deformed state.

In an embodiment, any of the haptic actuators discussed above may further include a vibrotactile haptic effect generator, such as a piezoelectric vibrator, in order to generate a combination of a kinesthetic haptic effect and a vibratory haptic effect.

Additional Discussion of Various Embodiments:

Embodiment 1 relates to a haptic actuator for generating bending deformation. The haptic actuator comprises an elongate bladder, a pressure control component, and a constraining structure. The elongate bladder comprises a layer of elastic material formed to enclose a fluid, wherein the elongate bladder is stretchable along at least a length dimension thereof. The pressure control component is configured, when activated, to cause an increase in pressure of the fluid enclosed by the elongate bladder, wherein the increase in the pressure of the fluid causes at least a first surface portion of the elongate bladder to stretch along the length dimension thereof. The constraining structure is flexible and is attached to a second surface portion of the elongate bladder, wherein the first surface portion and the second surface portion are diametrically opposed to each other, wherein the constraining structure is less stretchable than the elongate bladder so as to constrain the second surface portion of the elongate bladder from stretching along the length dimension thereof. When the pressure control component is activated to increase the pressure of the fluid, the constraining structure permits the first surface portion of the elongate bladder to stretch along the length dimension by a greater amount relative to the second surface portion, and wherein the greater amount of stretching on the first surface portion of the elongate bladder relative to the second surface portion thereof is configured to bend the elongate bladder.

Embodiment 2 includes the haptic actuator of embodiment 1, wherein the constraining structure is a first constraining structure. In this embodiment, the haptic actuator further comprises a second constraining structure that is a coil having a plurality of turns and wrapped around the elongate bladder, or is a sleeve wrapped around the elongate bladder, wherein the second constraining structure is configured to constrain the elongate bladder from stretching along a second dimension thereof perpendicular to the length dimension.

Embodiment 3 includes the haptic actuator of embodiment 2, wherein a size of the second constraining structure along a length dimension thereof is substantially equal to a size of the elongate bladder along the length dimension thereof.

Embodiment 4 includes the haptic actuator of embodiment 2 or 3, wherein the second dimension of the elongate bladder is a radial dimension, width dimension, or height dimension thereof.

Embodiment 5 includes the haptic actuator of any one of embodiments 1-4, wherein the elongate bladder is formed from an elastomeric material, and wherein the constraining structure is a flat or curved sheet formed from glass fibers or carbon fibers.

Embodiment 6 includes the haptic actuator of embodiment 5, wherein the elongate bladder is shaped as a cylindrical tube, and wherein the constraining structure is another cylindrical tube attached to the elongate bladder, or is an elongate sheet having a concavo-convex cross section that follows a contour of the elongate bladder and is attached to the elongate bladder.

Embodiment 7 includes the haptic actuator of embodiment 5 or 6, wherein a Young's Modulus of the constraining structure along a length dimension thereof is at least 10 times higher than a Young's Modulus of the elongate bladder along the length dimension thereof.

Embodiment 8 includes the haptic actuator of any one of embodiments 2-7, wherein the pressure control component comprises a compressing apparatus configured, when activated, to compress the elongate bladder along the second dimension of the elongate bladder to increase the pressure of the fluid therein.

Embodiment 9 includes the haptic actuator of embodiment 8, wherein the coil of the second constraining structure is a shape memory alloy (SMA) coil that is formed from a fiber of shape memory alloy (SMA), wherein the compressing apparatus further comprises a heating device that is configured to activate the SMA coil, wherein the SMA coil, when activated, is configured to shrink in radius to compress the elongate bladder along the second dimension thereof.

Embodiment 10 includes the haptic actuator of any one of embodiments 1-9, wherein the layer of elastic material of the elongate bladder comprises a shape memory polymer (SMP), and wherein the haptic actuator further comprises a SMP stimulation apparatus that is configured, when activated, to apply at least one of a thermal stimulus or electrical stimulus to the elongate bladder, wherein the SMP of the elongate bladder is configured to transition from an unbent shape to a bent shape upon being applied with the thermal stimulus or electrical stimulus.

Embodiment 11 includes the haptic actuator of any one of embodiments 8-10, wherein the compressing apparatus comprises an electroactive polymer (EAP) component configured, when activated, to expand in thickness to press against at least the first surface portion or the second surface portion of the elongate bladder to compress the elongate bladder along the second dimension thereof.

Embodiment 12 includes the haptic actuator of embodiment 11, wherein the EAP component comprises a layer of polyvinylidene fluoride (PVDF) material and two electrodes disposed on opposite sides of the layer of PVDF material, wherein the layer of PVDF material is configured to increase in thickness when there is a voltage difference between the two electrodes.

Embodiment 13 includes the haptic actuator of any one of embodiments 8-12, wherein the compressing apparatus comprises: a first electrode disposed on the first surface portion of the elongate bladder; a second electrode disposed on the second surface portion of the elongate bladder; and a layer of a dielectric elastomer that surrounds the elongate bladder, wherein the layer of the dielectric elastomer is disposed between the first electrode and the second electrode, and wherein the first electrode and the second electrode are configured to compress the elongate bladder along the second dimension thereof when there is a voltage difference between the first electrode and the second electrode.

Embodiment 14 includes the haptic actuator of any one of embodiments 2-13, wherein the fluid enclosed within the elongate bladder includes a hydrogel, and wherein the pressure control component comprises a hydrogel stimulation apparatus configured, when activated, to apply at least one of an electrical stimulus, magnetic stimulus, thermal stimulus, or chemical stimulus to cause the hydrogel to expand, wherein expansion of the hydrogel stretches the first surface portion of the elongate bladder along the first dimension thereof, and wherein when the hydrogel stimulation apparatus is activated, the constraining structure causes the first surface portion to stretch by the greater amount relative to the second surface portion, so as to bend the elongate bladder.

Embodiment 15 includes the haptic actuator of any one of embodiments 2-14, wherein the pressure control component comprises a pneumatic or hydraulic pump that is configured, when activated, to increase the pressure of the fluid therein.

Embodiment 16 includes the haptic actuator of any one of embodiments 1-15, wherein the constraining structure comprises a layer of electroactive polymer (EAP) material directly attached to the elongate bladder and comprises two electrodes disposed at opposite ends of the layer of EAP material. The pressure control component comprises a heating device and comprises a SMA coil wrapped around the elongate bladder and the constraining structure. A voltage difference between the two electrodes causes the layer of EAP material to contract along the length dimension of the elongate bladder. The contraction may thus prevent the constraining structure from stretching along the length dimension of the elongate bladder, and thus prevents the second surface portion of the elongate bladder from stretching along the length dimension of the elongate bladder, or causes the second surface portion to stretch by a smaller amount relative to how much the first surface portion stretches along the length dimension.

While various embodiments have been described above, it should be understood that they have been presented only as illustrations and examples of the present invention, and not by way of limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other embodiment. All patents and publications discussed herein are incorporated by reference herein in their entirety.

What is claimed is:

1. A haptic actuator for generating bending deformation, comprising:
an elongate bladder comprising a layer of elastic material formed to enclose a fluid, wherein the elongate bladder is stretchable along at least a length dimension thereof;
a pressure control component configured, when activated, to cause an increase in pressure of the fluid enclosed by the elongate bladder, wherein the increase in the pressure of the fluid causes at least a first surface portion of the elongate bladder to stretch along the length dimension thereof; and
a constraining structure that is flexible and attached to a second surface portion of the elongate bladder, wherein the first surface portion and the second surface portion are diametrically opposed to each other, wherein the constraining structure is less stretchable than the elongate bladder so as to constrain the second surface portion of the elongate bladder from stretching along the length dimension thereof,
wherein when the pressure control component is activated to increase the pressure of the fluid, the constraining structure permits the first surface portion of the elongate bladder to stretch along the length dimension by a greater amount relative to the second surface portion, and wherein the greater amount of stretching on the first surface portion of the elongate bladder relative to the second surface portion thereof is configured to bend the elongate bladder.

2. The haptic actuator of claim 1, wherein the constraining structure is a first constraining structure, the haptic actuator further comprising a second constraining structure that is a coil having a plurality of turns and wrapped around the elongate bladder, or is a sleeve wrapped around the elongate bladder, wherein the second constraining structure is configured to constrain the elongate bladder from stretching along a second dimension thereof perpendicular to the length dimension.

3. The haptic actuator of claim 2, wherein a size of the second constraining structure along a length dimension thereof is substantially equal to a size of the elongate bladder along the length dimension thereof.

4. The haptic actuator of claim 2, wherein the second dimension of the elongate bladder is a radial dimension, width dimension, or height dimension thereof.

5. The haptic actuator of claim 1, wherein the elongate bladder is formed from an elastomeric material, and wherein the constraining structure is a flat or curved sheet formed from glass fibers, or carbon fibers.

6. The haptic actuator of claim 5, wherein the elongate bladder is shaped as a cylindrical tube, and wherein the constraining structure is another cylindrical tube attached to the elongate bladder, or is an elongate sheet having a concavo-convex cross section that follows, partly or entirely, a contour of the elongate bladder and is attached to the elongate bladder.

7. The haptic actuator of claim 5, wherein a Young's Modulus of the constraining structure along a length dimension thereof is at least 10 times higher than a Young's Modulus of the elongate bladder along the length dimension thereof.

8. The haptic actuator of claim 2, wherein the pressure control component comprises a compressing apparatus configured, when activated, to compress the elongate bladder along the second dimension of the elongate bladder to increase the pressure of the fluid therein.

9. The haptic actuator of claim 8, wherein the coil of the second constraining structure is a shape memory alloy (SMA) coil that is formed from a fiber of shape memory alloy (SMA), wherein the compressing apparatus further comprises a heating device that is configured to activate the SMA coil, wherein the SMA coil, when activated, is configured to shrink in radius to compress the elongate bladder along the second dimension thereof.

10. The haptic actuator of claim 9, wherein the layer of elastic material of the elongate bladder comprises a shape memory polymer (SMP), and wherein the haptic actuator further comprises a SMP stimulation apparatus that is configured, when activated, to apply at least one of a thermal stimulus or electrical stimulus to the elongate bladder, wherein the SMP of the elongate bladder is configured to transition from an unbent shape to a bent shape upon being applied with the thermal stimulus or electrical stimulus.

11. The haptic actuator of claim 8, wherein the compressing apparatus comprises an electroactive polymer (EAP) component configured, when activated, to expand in thickness to press against at least the first surface portion or the second surface portion of the elongate bladder to compress the elongate bladder along the second dimension thereof.

12. The haptic actuator of claim 11, wherein the EAP component comprises a layer of polyvinylidene fluoride (PVDF) material and two electrodes disposed on opposite sides of the layer of PVDF material, wherein the layer of PVDF material is configured to increase in thickness when there is a voltage difference between the two electrodes.

13. The haptic actuator of claim 8, wherein the compressing apparatus comprises:
a first electrode disposed on the first surface portion of the elongate bladder;
a second electrode disposed on the second surface portion of the elongate bladder; and
a layer of a dielectric elastomer that surrounds the elongate bladder, wherein the layer of the dielectric elastomer is disposed between the first electrode and the second electrode, and wherein the first electrode and the second electrode are configured to compress the elongate bladder along the second dimension thereof when there is a voltage difference between the first electrode and the second electrode.

14. The haptic actuator of claim 2, wherein the fluid enclosed within the elongate bladder includes a hydrogel, and wherein the pressure control component comprises a hydrogel stimulation apparatus configured, when activated, to apply at least one of an electrical stimulus, magnetic stimulus, thermal stimulus, or chemical stimulus to cause the hydrogel to expand, wherein expansion of the hydrogel stretches the first surface portion of the elongate bladder along the first dimension thereof, and
wherein when the hydrogel stimulation apparatus is activated, the constraining structure causes the first surface portion to stretch by the greater amount relative to the second surface portion, so as to bend the elongate bladder.

15. The haptic actuator of claim 2, wherein the pressure control component comprises a pneumatic or hydraulic pump that is configured, when activated, to increase the pressure of the fluid therein.

16. The haptic actuator of claim 1, wherein the constraining structure comprises a layer of electroactive polymer (EAP) material directly attached to the elongate bladder and comprises two electrodes disposed at opposite ends of the layer of EAP material, and wherein the pressure control component comprises a heating device and comprises a SMA coil wrapped around the elongate bladder and the constraining structure, wherein a voltage difference between the two electrodes causes the layer of EAP material to contract along the length dimension of the elongate bladder.
